(19) United States
(12) Patent Application Publication
(10) Pub. No.: US 2024/0363881 A1
(43) Pub. Date: Oct. 31, 2024

(54) ELECTROCHEMICAL REBALANCING METHODS

(71) Applicant: President and Fellows of Harvard College, Cambridge, MA (US)

(72) Inventors: Shijian JIN, Cambridge, MA (US); Yan JING, Cambridge, MA (US); Michael J. AZIZ, Cambridge, MA (US); Roy G. GORDON, Cambridge, MA (US)

(21) Appl. No.: 18/685,969

(22) PCT Filed: Aug. 23, 2022
(86) PCT No.: PCT/US2022/041188

§ 371 Date: Feb. 23, 2024

Related U.S. Application Data
(60) Provisional application No. 63/236,169, filed on Aug. 23, 2021.

(51) Int. Cl. H01M 8/18; H01M 8/083

(52) U.S. Cl. CPC H01M 8/188; H01M 8/083

(57) ABSTRACT

The invention provides methods of electrochemically rebalancing electrochemical systems such as flow batteries and electrochemical CO₂ capture systems. Electrochemical imbalances due to reaction with molecular oxygen can lead to capacity loss. The loss of capacity may be mitigated by electrically oxidizing the excess hydroxide ions to produce gaseous O₂, which can be removed by de-gassing methods.

### STATEMENT REGARDING FEDERALLY SPONSORED RESEARCH

This invention was made with government support under DE-AC05-76RLD1830, awarded by the Department of Energy. The government has certain rights in the invention.

### BACKGROUND OF THE INVENTION

Accumulating CO₂ emissions from the burning of fossil fuels are resulting in an alarming rate of climate change. Consequently, there are increasing efforts worldwide to reduce societal reliance on fossil fuel-based energy and to switch to carbon-free sources such as solar and wind. However, due to the intermittent nature of solar and wind power, integrating them into the grid requires grid-scale energy storage. So far, most of the energy storage is achieved by pumped-hydroelectric and lithium-ion batteries. The former is limited by its geographical requirement while the latter is unsuitable for long-duration discharge due to its coupled energy and power, not to mention its flammable nature and difficulty in recyclability.

Aqueous organic redox flow batteries (AORFB) provide a much better solution to energy storage. They have decoupled energy and power, so that one can increase the power just by increasing the stack size while independently controlling the capacity/energy by controlling the size of the electrolyte reservoirs. This allows AORFBs to discharge for an arbitrary amount of time, which is ideal for grid-scale energy storage. Since the solvent of electrolytes is just water, it is nonflammable. The redox active organic materials are simple organics that are potentially inexpensive, scalable through facile synthesis and easily recyclable, making them strong competitors to existing technologies. While the energy storage methods promise to reduce carbon emission in the future, carbon capture, e.g., carbon capture and sequestration (CCS) (e.g., capture from flue gas) or direct air capture (DAC), is required to avoid severe consequences of global warming (greater than 2° C. above pre-industrial era levels) and irreversibly deleterious changes to natural habitats and ecosystems that would threaten the viability of human civilization.

In addition to power storage, the organic molecules used in AORFB can be used for carbon capture. Molecules that undergo proton-coupled electron transfers (PCET), change the solution pH from near neutral to highly basic during charging, and from highly basic to near neutral during discharging. In other words, hydroxide is reversibly generated during charging and consumed during discharging. Since hydroxide binds with CO₂ to form carbonate and then bicarbonate, the electrolyte captures CO₂ upon charging and releases CO₂ upon discharging. The energy cost for capturing from a 0.1 bar CO₂ stream and releasing into a 1 bar stream at 40 mA/cm² costs 86 KJ/molCO₂, which is highly competitive compared to traditional amine scrubbing processes that typically cost more than 100 KJ/molCO₂. In addition, electrochemical flow cell capture systems such as those described herein rely solely on electrical work, while amine scrubbing requires high thermal input, and the amines and related decomposition products are volatile and environmental hazards. For air capture, redox flow methods such as described herein are projected to cost 110 KJ/molCO₂ at 40 mA/cm², which is again very competitive compared with existing technologies costing more than 150 KJ/molCO₂.

The above systems require an oxygen-free environment. This is because when the redox active organic molecules are reduced (e.g., when the systems are charged), they may be susceptible to oxidation by molecular oxygen, thereby stopping the discharge process from happening, causing an incomplete cycle and, e.g., resulting an accumulation of hydroxide and dissolved carbon species in the electrolyte. Eventually the device, whether a battery or carbon capture device, will be fully oxidized in both sides and no longer functional. In real life application, a perfectly sealed flow battery is difficult to achieve. Even if initially perfectly sealed, external factors such as aging of cell components or the sealing material, extreme weather, geological changes or even vandalism may cause molecular oxygen to come into contact with the electrolyte. For carbon capture, molecular oxygen is almost always unavoidable, as there is 1 to 3% of oxygen in factory flue gas and ˜20% oxygen in air. Therefore, mitigating the adverse effect of oxygen is essential to the operation of an AORFB and electrochemical carbon capture flow cell.

### SUMMARY OF THE INVENTION

The invention features methods to extend the life of electrochemical systems by electrochemically rebalancing electrolytes unbalanced by reaction of redox active species with molecular oxygen.

An aspect of the invention provides a method of rebalancing an electrochemical device including providing an electrochemical device including a negolyte including a first redox active species having an oxidized form and a reduced form in contact with a first electrode, a posolyte including a second redox active species having an oxidized form and a reduced form in contact with a second electrode, and a barrier separating the negolyte and posolyte. When the electrochemical device is charged, the reduced form of the first redox active species reacts with molecular oxygen to form the oxidized form of the first redox active species while the second redox active species remains in the oxidized form, thereby electrochemically unbalancing the electrochemical device. A discharge reaction or reaction with molecular oxygen produces an OH⁻ ion. The method includes applying an electrical pulse across the electrochemical device sufficient to produce a gaseous oxidation product (e.g., molecular oxygen) in the negolyte. The electrical pulse may also revert the oxidized form of the second redox active species to the reduced form of the second redox active species. The device may be operated symmetrically, i.e., where the first and second redox active species cycle between oxidized and reduced forms of the same redox active species. Alternatively, the first and second redox active species may cycle between different oxidized and reduced forms.

In some embodiments, the method further includes removing the gaseous oxidation product from the negolyte. In some embodiments, the electrical pulse is applied every 100 cycles. In some embodiments, the gaseous oxidation product is removed by flowing a carrier gas through the electrochemical device or by applying negative pressure to the negolyte. In some embodiments, the electrical pulse lowers the pH of the negolyte.

In some embodiments, the method further includes monitoring a capacity of the electrochemical device or a pH of the negolyte to determine when to apply the pulse. In some embodiments, the pulse is applied when the pH is greater than 9, e.g., is about 14. In some embodiments, the pulse is applied when the capacity is below 90% of an initial capacity.

In some embodiments, the electrochemical device provided is a battery (e.g., a flow battery), and the method further includes applying a voltage across the first and second electrodes charging the battery and connecting a load to the first and second electrodes allowing the battery to discharge. In some embodiments, the method further includes biasing the battery at a voltage more negative than a discharging voltage of the battery. In some embodiments, the gaseous oxidation product is molecular oxygen, and the method incudes oxidizing OH⁻ or H₂O in the negolyte to molecular oxygen.

In some embodiments, the electrochemical device is a carbon capture cell (e.g., a carbon capture flow cell), and the method further includes applying a voltage across the first and second electrodes to charge the electrochemical device and produce OH⁻ ions, providing a source of CO₂ to the negolyte to capture the CO₂ therein, e.g., by dissolution or reaction with the OH⁻ ions, and connecting a load to the first and second electrodes and allowing the electrochemical device to discharge and release CO₂.

By “about” is meant ±10% of a recited value.

By “alkoxy” is meant a group of formula —OR, where R is an alkyl group, as defined herein.

By “alkyl” is meant straight chain or branched saturated groups from 1 to 6 carbons. Alkyl groups are exemplified by methyl, ethyl, n- and iso-propyl, n-, sec-, iso- and tert-butyl, neopentyl, and the like, and may be optionally substituted with one or more, substituents.

By “alkylene” is meant a divalent alkyl group.

By “alkyl thio” is meant —SR, where R is an alkyl group, as defined herein.

By “alkyl ester” is meant —COOR, where R is an alkyl group, as defined herein.

By “aryl” is meant an aromatic cyclic group in which the ring atoms are all carbon. Exemplary aryl groups include phenyl, naphthyl, and anthracenyl. Aryl groups may be optionally substituted with one or more substituents.

By “carbocyclyl” is meant a non-aromatic cyclic group in which the ring atoms are all carbon. Exemplary carbocyclyl groups include cyclopropyl, cyclobutyl, cyclopentyl, cyclohexyl, cycloheptyl, and cyclooctyl. Carbocyclyl groups may be optionally substituted with one or more substituents.

By “halo” is meant, fluoro, chloro, bromo, or iodo.

By “hydroxyl” is meant-OH. An exemplary ion of hydroxyl is —O⁻.

By “amino” is meant —NH₂. An exemplary ion of amino is —NH₃⁺.

By “nitro” is meant —NO₂.

By “carboxyl” is meant —COOH. An exemplary ion of carboxyl is —COO.

By “phosphoryl” is meant —PO₃H₂. Exemplary ions of phosphoryl are —PO₃H⁻ and —PO₃²⁻.

By “phosphonyl” is meant —PO₃R₂, where each R is H or alkyl, provided at least one R is alkyl, as defined herein. An exemplary ion of phosphoryl is —PO₃R⁻.

By “oxo” is meant ═O.

By “sulfonyl” is meant —SO₃H. An exemplary ion of sulfonyl is —SO₃⁻.

By “thiol” is meant —SH.

By “heteroaryl” is meant an aromatic cyclic group in which the ring atoms include at least one carbon and at least one O, N, or S atom, provided that at least three ring atoms are present. Exemplary heteroaryl groups include oxazolyl, isoxazolyl, tetrazolyl, pyridyl, thienyl, furyl, pyrrolyl, imidazolyl, pyrimidinyl, thiazolyl, indolyl, quinolinyl, isoquinolinyl, benzofuryl, benzothienyl, pyrazolyl, pyrazinyl, pyridazinyl, isothiazolyl, benzimidazolyl, benzothiazolyl, benzoxazolyl, oxadiazolyl, thiadiazolyl, and triazolyl. Heteroaryl groups may be optionally substituted with one or more substituents.

By “heteroalkylene” is meant an alkylene group in which one or more CH₂ units are replaced with one or more heteroatoms selected from O, N, and S. Heteroalkylene groups can be substituted by oxo (═O). An exemplary heteroalkylene includes an amido group, e.g., —(CH₂)ₙC(O)NH(CH₂)ₘ—, wherein n and m are independently 1-6.

By “heterocyclyl” is meant a non-aromatic cyclic group in which the ring atoms include at least one carbon and at least one O, N, or S atom, provided that at least three ring atoms are present. Exemplary heterocyclyl groups include epoxide, thiiranyl, aziridinyl, azetidinyl, thietanyl, dioxetanyl, morpholinyl, thiomorpholinyl, piperazinyl, piperidinyl, pyrrolidinyl, tetrahydropyranyl, tetrahydrofuranyl, dihydrofuranyl, tetrahydrothienyl, dihydrothienyl, dihydroindolyl, tetrahydroquinolyl, tetrahydroisoquinolyl, pyranyl, pyrazolinyl, pyrazolidinyl, dihydropyranyl, tetrahydroquinolyl, imidazolinyl, imidazolidinyl, pyrrolinyl, oxazolidinyl, isoxazolidinyl, thiazolidinyl, isothiazolidinyl, dithiazolyl, and 1,3-dioxanyl. Heterocyclyl groups may be optionally substituted with one or more substituents.

By “hydrocarbyl” is meant a branched, unbranched, cyclic, or acyclic group including the elements C and H. Hydrocarbyl groups may be monovalent, e.g., alkyl, or divalent, e.g., alkylene. Hydrocarbyl groups may be substituted with groups including oxo (═O).

By an “oxygen protecting group” is meant those groups intended to protect an oxygen containing (e.g., phenol, hydroxyl, or carbonyl) group against undesirable reactions during synthetic procedures. Commonly used oxygen protecting groups are disclosed in Greene, “Protective Groups in Organic Synthesis,” 3rd Edition (John Wiley & Sons, New York, 1999), which is incorporated herein by reference. Exemplary oxygen protecting groups include acyl, aryloyl, or carbamyl groups, such as formyl, acetyl, propionyl, pivaloyl, t-butylacetyl, 2-chloroacetyl, 2-bromoacetyl, trifluoroacetyl, trichloroacetyl, phthalyl, o-nitrophenoxyacetyl, α-chlorobutyryl, benzoyl, 4-chlorobenzoyl, 4-bromobenzoyl, t-butyldimethylsilyl, tri-iso-propylsilyloxymethyl, 4,4′-dimethoxytrityl, isobutyryl, phenoxyacetyl, 4-isopropylpehenoxyacetyl, dimethylformamidino, and 4-nitrobenzoyl; alkylcarbonyl groups, such as acyl, acetyl, propionyl, and pivaloyl; optionally substituted arylcarbonyl groups, such as benzoyl; silyl groups, such as trimethylsilyl (TMS), tert-butyldimethylsilyl (TBDMS), tri-iso-propylsilyloxymethyl (TOM), and triisopropylsilyl (TIPS); ether-forming groups with the hydroxyl, such methyl, methoxymethyl, tetrahydropyranyl, benzyl, p-methoxybenzyl, and trityl; alkoxycarbonyls, such as methoxycarbonyl, ethoxycarbonyl, isopropoxycarbonyl, n-isopropoxycarbonyl, n-butyloxycarbonyl, isobutyloxycarbonyl, sec-butyloxycarbonyl, t-butyloxycarbonyl, 2-ethylhexyloxycarbonyl, cyclohexyloxycarbonyl, and methyloxycarbonyl; alkoxyalkoxycarbonyl groups, such as methoxymethoxycarbonyl, ethoxymethoxycarbonyl, 2-methoxyethoxycarbonyl, 2-ethoxyethoxycarbonyl, 2-butoxyethoxycarbonyl, 2-methoxyethoxymethoxycarbonyl, allyloxycarbonyl, propargyloxycarbonyl, 2-butenoxycarbonyl, and 3-methyl-2-butenoxycarbonyl; haloalkoxycarbonyls, such as 2-chloroethoxycarbonyl, 2-chloroethoxycarbonyl, and 2,2,2-trichloroethoxycarbonyl; optionally substituted arylalkoxycarbonyl groups, such as benzyloxycarbonyl, p-methylbenzyloxycarbonyl, p-methoxybenzyloxycarbonyl, p-nitrobenzyloxycarbonyl, 2,4-dinitrobenzyloxycarbonyl, 3,5-dimethylbenzyloxycarbonyl, p-chlorobenzyloxycarbonyl, p-bromobenzyloxy-carbonyl, and fluorenylmethyloxycarbonyl; and optionally substituted aryloxycarbonyl groups, such as phenoxycarbonyl, p-nitrophenoxycarbonyl, o-nitrophenoxycarbonyl, 2,4-dinitrophenoxycarbonyl, p-methyl-phenoxycarbonyl, m-methylphenoxycarbonyl, o-bromophenoxycarbonyl, 3,5-dimethylphenoxycarbonyl, p-chlorophenoxycarbonyl, and 2-chloro-4-nitrophenoxy-carbonyl); substituted alkyl, aryl, and alkaryl ethers (e.g., trityl; methylthiomethyl; methoxymethyl; benzyloxymethyl; siloxymethyl; 2,2,2,-trichloroethoxymethyl; tetrahydropyranyl; tetrahydrofuranyl; ethoxyethyl; 1-[2-(trimethylsilyl) ethoxy]ethyl; 2-trimethylsilylethyl; t-butyl ether; p-chlorophenyl, p-methoxyphenyl, p-nitrophenyl, benzyl, p-methoxybenzyl, and nitrobenzyl); silyl ethers (e.g., trimethylsilyl; triethylsilyl; triisopropylsilyl; dimethylisopropylsilyl; t-butyldimethylsilyl; t-butyldiphenylsilyl; tribenzylsilyl; triphenylsilyl; and diphenymethylsilyl); carbonates (e.g., methyl, methoxymethyl, 9-fluorenylmethyl; ethyl; 2,2,2-trichloroethyl; 2-(trimethylsilyl)ethyl; vinyl, allyl, nitrophenyl; benzyl; methoxybenzyl; 3,4-dimethoxybenzyl;

and nitrobenzyl); carbonyl-protecting groups (e.g., acetal and ketal groups, such as dimethyl acetal, and 1,3-dioxolane; acylal groups; and dithiane groups, such as 1,3-dithianes, and 1,3-dithiolane); carboxylic acid-protecting groups (e.g., ester groups, such as methyl ester, benzyl ester, t-butyl ester, and orthoesters; and oxazoline groups.

By a “nitrogen protecting group” is meant those groups intended to protect an amino group against undesirable reactions during synthetic procedures. Commonly used nitrogen protecting groups are disclosed in Greene, “Protective Groups in Organic Synthesis,” 3rd Edition (John Wiley & Sons, New York, 1999), which is incorporated herein by reference. Nitrogen protecting groups include acyl, aryloyl, or carbamyl groups such as formyl, acetyl, propionyl, pivaloyl, t-butylacetyl, 2-chloroacetyl, 2-bromoacetyl, trifluoroacetyl, trichloroacetyl, phthalyl, o-nitrophenoxyacetyl, α-chlorobutyryl, benzoyl, 4-chlorobenzoyl, 4-bromobenzoyl, 4-nitrobenzoyl, and amino acids such as alanine, leucine, and phenylalanine; sulfonyl-containing groups such as benzenesulfonyl, and p-toluenesulfonyl; carbamate forming groups such as benzyloxycarbonyl, p-chlorobenzyloxycarbonyl, p-methoxybenzyloxycarbonyl, p-nitrobenzyloxycarbonyl, 2-nitrobenzyloxycarbonyl, p-bromobenzyloxycarbonyl, 3,4-dimethoxybenzyloxycarbonyl, 3,5-dimethoxybenzyloxycarbonyl, 2,4-dimethoxybenzyloxycarbonyl, 4-methoxybenzyloxycarbonyl, 2-nitro-4,5-dimethoxybenzyloxycarbonyl, 3,4,5-trimethoxybenzyloxycarbonyl, 1-(p-biphenylyl)-1-methylethoxycarbonyl, α,α-dimethyl-3,5-dimethoxybenzyloxycarbonyl, benzhydryloxy carbonyl, t-butyloxycarbonyl, diisopropylmethoxycarbonyl, isopropyloxycarbonyl, ethoxycarbonyl, methoxycarbonyl, allyloxycarbonyl, 2,2,2,-trichloroethoxycarbonyl, phenoxycarbonyl, 4-nitrophenoxy carbonyl, fluorenyl-9-methoxycarbonyl, cyclopentyloxycarbonyl, adamantyloxycarbonyl, cyclohexyloxycarbonyl, and phenylthiocarbonyl, alkaryl groups such as benzyl, triphenylmethyl, and benzyloxymethyl, and silyl groups, such as trimethylsilyl. Preferred nitrogen protecting groups are alloc, formyl, acetyl, benzoyl, pivaloyl, t-butylacetyl, alanyl, phenylsulfonyl, benzyl, t-butyloxycarbonyl (Boc), and benzyloxycarbonyl (Cbz).

For the purposes of this invention, the term “quinone” includes a compound having one or more conjugated, C₃₋₁₀ carbocyclic, fused rings, substituted, in oxidized form, with two or more oxo groups, which are in conjugation with the one or more conjugated rings. Preferably, the number of rings is from one to ten, e.g., one, two, or three, and each ring has 6 members.

As noted, substituents may be optionally substituted with halo, optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ; —N(Rₐ)₂; —C(═O)Rₐ; —C(═O)ORₐ; —S(═O)₂Rₐ; —S(═O)₂ORₐ; —P(═O)Rₐ₂; —O—P(═O)(ORₐ)₂, or —P(═O)(ORₐ)₂, or an ion thereof; where each Rₐ is independently H, C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. Cyclic substituents may also be substituted with optionally substituted C₁₋₆ alkyl. In specific embodiments, substituents may include optionally substituted with halo, optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —NO₂; —ORₐ; —N(Rₐ)₂; —C(═O)Rₐ; —C(═O)ORₐ; —S(═O)₂Rₐ; —S(═O)₂ORₐ; —P(═O)Rₐ₂; —O—P(═O)(ORₐ)₂, or —P(═O)(ORₐ)₂, or an ion thereof; where each Rₐ is independently H, C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group, and cyclic substituents may also be substituted with C₁₋₆ alkyl. In specific embodiments, alkyl groups may be optionally substituted with one, two, three, or, in the case of alkyl groups of two carbons or more, four substituents independently selected from the group consisting of halo, hydroxyl, C₁₋₆ alkoxy, SO₃H, amino, nitro, carboxyl, phosphoryl, phosphonyl, thiol, C₁₋₆ alkyl ester, optionally substituted C₁₋₆ alkyl thio, and oxo, or an ion thereof.

Exemplary ions of substituent groups are as follows: an exemplary ion of hydroxyl is —O⁻; an exemplary ion of —COOH is —COO⁻; exemplary ions of —PO₃H₂ are —PO₃H⁻ and —PO₃²⁻; an exemplary ion of —PO₃HRₐ is —PO₃Rₐ⁻, where Ra is not H; exemplary ions of —PO₄H₂ are —PO₄H⁻ and —PO₄²⁻; and an exemplary ion of —SO₃H is —SO₃⁻.

### BRIEF DESCRIPTION OF THE DRAWINGS

FIG. 1 is an illustration of a Fe(CN)₆ (positive electrolyte or posolyte)|Q (negative electrolyte or negolyte) flow cell for CO₂ capture. The region enclosed by the dashed rectangle is a flow battery.

FIGS. 2A-2B are graphs of capacity (C) vs. cycle number during cycling of a Fe(CN)₆ (posolyte)|3,3′-(phenazine-2,3-diyl)bis(propane-1-sulfonate) (DSPZ) (negolyte) flow battery under N₂ (FIG. 2A) and under air (FIG. 2B).

FIGS. 3A-3D are graphs showing characteristics of the electrochemical rebalancing process (process #4, see below) over time, including: The voltage profile (FIG. 3A); the applied current density (held at −40 mA/cm²) (FIG. 3B); the posolyte pH (FIG. 3C); and the negolyte pH (FIG. 3D). The negolyte pH dropped from ˜14 to ˜7 during the electrochemical rebalancing.

FIG. 4 is a graph of capacity (C) vs. cycle number during cycling of the post-rebalancing cell under N₂. The capacities were almost identical to the pre-air-exposure battery in FIG. 2A, suggesting the molecular decomposition is caused by this method.

### DETAILED DESCRIPTION OF THE INVENTION

Here we demonstrate a simple yet effective method, called electrochemical rebalancing, that can remove the adverse effect of molecular oxygen on electrochemical systems. The methods ameliorate the deleterious impacts of reaction with molecular oxygen with only a small energy cost.

This method involves coupling an anodic gaseous oxidation product (e.g., molecular oxygen or CO₂) evolution reaction in the negolyte reservoir, with the cathodic reduction reaction in the posolyte reservoir through the application of an electrical pulse to the imbalanced electrochemical system. The system may be symmetrical or asymmetrical, i.e., the posolyte and negolyte may include redox active species that can cycle between the same redox states or between different redox states. When the system is completely out-of-balance, both sides are oxidized, e.g., electrochemically or by reaction with molecular oxygen, and reduction may occur on either side. When the system is partially out-of-balance, e.g., one side is 100% oxidized while the other sized is partially oxidized, reduction may also occur on either side, with accompanying oxygen evolution on the other side. The side on which reduction occurs during discharge is referred to as the posolyte herein.

In an embodiment, the method involves coupling an anodic oxygen evolution reaction in the negolyte reservoir with cathodic Fe(CN)₆³⁻ reduction reaction in the posolyte reservoir (see, e.g., Table 1). After the electrochemical rebalancing step, the posolyte side will once again be in reduced form (Fe(CN)₆⁴⁻) and the accumulated hydroxide in the negolyte side all converts to oxygen (and water), which is carried away by a carrier gas such as nitrogen. In other words, the initial healthy state of the electrochemical system (e.g., battery or carbon capture cell) is restored by this method.

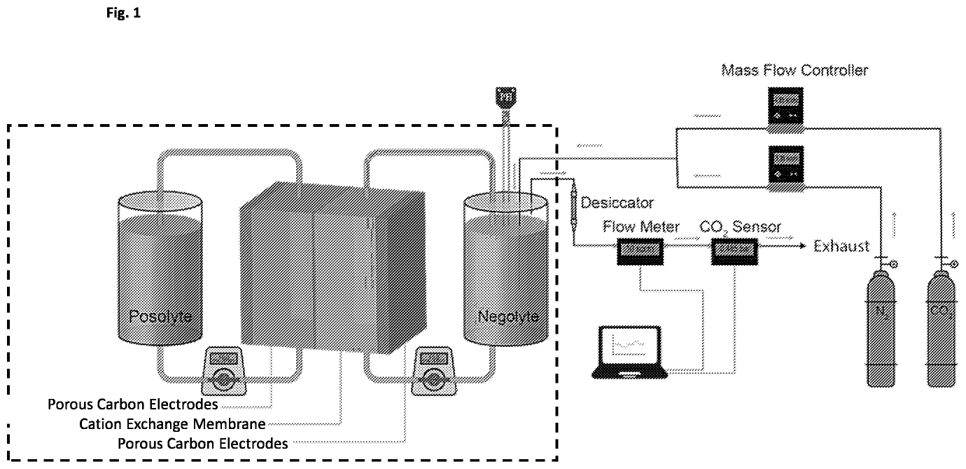

The scheme of a typical setup is shown in FIG. 1. Table 1 shows an exemplary sequence of reactions for PCET. Q denotes a generic organic molecule that undergoes PCET used in negolytes.

TABLE 1
Reactions taking place in an AORFB or an electrochemical carbon capture flow cell.

| # | Process Name | Posolyte Reaction | Negolyte Reaction |
|---|---|---|---|
| 1 | Charge (Deacidification) | 2Fe(CN)₆⁴⁻ → 2Fe(CN)₆³⁻ + 2e⁻ | Q + 2H₂O + 2e⁻ → QH₂ + 2OH⁻ |
| 2 | CO₂ Capture | N/A | 2OH⁻ + 2CO₂ → 2HCO₃⁻ |
| 3 | Oxidation by Oxygen | N/A | QH₂ + ½ O₂ → Q + H₂O |
| 4 | Electrochemical Rebalancing | 2Fe(CN)₆³⁻ + 2e⁻ → 2Fe(CN)₆⁴⁻ | 2OH⁻ → ½O₂ + H₂O + 2e⁻ |
| 5 | CO₂ Evolution Induced by | N/A | 2HCO₃⁻ → 2OH⁻ + 2CO₂ |
| | Electrochemical Rebalancing | | |
| 6 | Discharge (Acidification) | 2Fe(CN)₆³⁻ + 2e⁻ → 2Fe(CN)₆⁴⁻ | QH₂ + 2OH⁻ → Q + 2H₂O + 2e⁻ |
| 7 | CO₂ Evolution | N/A | 2HCO₃⁻ → 2OH⁻ + 2CO₂ |

In Table 1, processes #1 (charge) and #6 (discharge) denote the normal reactions in an AORFB. Process #3 denotes the oxygen oxidation of reduced Q, i.e., QH₂. Note that after process #3, since oxygen has oxidized QH₂ to Q, process #6, can no longer proceed, as the negolyte now lacks QH₂. A consequence of not going through process #6 is the accumulation of hydroxide, which is produced in process #1, in the negolyte side, and the accumulation of Fe(CN)₆³⁻ in the posolyte side. In other words, process #3 not only causes the battery to discharge without generating electrical power, but also induces an imbalance of electrochemical species, which makes the battery un-rechargeable (cannot undergo process #1). One way to recover the initial condition of the battery is to replace the posolyte with fresh Fe(CN)₆⁴⁻ solution; as for the negolyte, the Q molecules need to be extracted from the out-of-balance solution and re-dissolved into a solution with the correct pH and supporting salt concentration. These additional remediations take enormous resources, including material, labor, and time and make the maintenance of such flow batteries impractically expensive.

Processes #2, #5, and #7 are processes related to PCET-mediated carbon capture. Process #2 denotes reaction of CO₂ with OH⁻ produced by process #1 to make HCO₃⁻ and/or CO₃²⁻ ions. Processes #7 denotes the reverse reaction of process #2, e.g., to release the captured CO₂, e.g., for storage. Process #5 denotes the CO₂ evolution reaction induced by the electrical pulse.

Here we introduce the electrochemical rebalancing method, an embodiment of which is shown as process #4. By applying a potential (e.g., via an electrical pulse) that causes process #4, the cell imbalance problem is solved. In embodiments such as shown in Table 1, the accumulated hydroxide in the negolyte is repelled from the solution in the form of oxygen, and the accumulated Fe(CN)₆³⁻ in the posolyte side is reduced to Fe(CN)₆⁴⁻. As a result, the initial, healthy battery composition is restored, and it can proceed with process #1 again. Other embodiments, using other posolytes and negolytes, e.g., negolytes that do not include proton-coupled changes in oxidation state, are amenable to the methods of the invention.

### Devices

Devices, e.g., batteries or carbon capture devices, such as those having flow cells, that may be rebalanced according to methods of the invention may include a negolyte that includes, e.g., an organic species, e.g., an anthrahydroquinone dissolved or suspended in aqueous solution; a posolyte that includes, e.g., a redox active species; and a barrier separating the two. The device, e.g., flow device, further includes at least two electrodes, one in contract with the negolyte and one in contact with the posolyte.

In some embodiments, the negolyte includes an organic species that is a hydroquinone. The hydroquinone may be a reduced form of an anthraquinone (e.g., as QH₂ in Table 1), e.g., of formula (I):

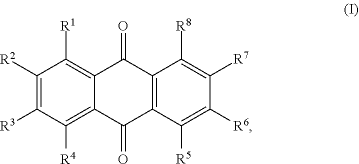

where each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, or an ion thereof, where each Ra is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. An anthraquinone of the invention may be a source of electrons during discharge and not merely a charge transfer agent. In embodiments, the anthraquinone is water soluble.

In certain embodiments, each of R¹, R², R³, R⁴, R⁵, R⁶, R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R¹, R², carboxyl, and SO₃H, such as each of R¹, R², R³, R⁴, R⁵, R⁶, R⁷ and R⁸ being independently selected from H, hydroxyl, optionally substituted C₁₋₄ alkyl (e.g., methyl), and oxo. In embodiments, at least one, e.g., at least two, of R¹, R², R³, R⁴, R⁵, R⁶, R⁷, and R⁸ is not H.

In other embodiments, the anthraquinone, such as a 9,10-anthraquinone, is substituted with at least one hydroxyl group and optionally further substituted with an optionally substituted C₁₋₄ alkyl, such as methyl. Exemplary quinones include 2,6-dihydroxy-9,10-anthraquinone (2,6-DHAQ), 1,5-dimethyl-2,6-dihydroxy-9,10-anthraquinone, 2,3,6,7-tetrahydroxy-9,10-anthraquinone, 1,3,5,7-tetrahydroxy-2,4,6,8-tetramethyl-9,10-anthraquinone, and 2,7-dihydroxy-1,8-dimethyl-9,10-anthraquinone. Ions and reduced species thereof are also contemplated. Quinones having one or more hydroxyl groups may include at least one carboxy C₁₋₄ alkyl (e.g., carboxymethyl) group. An exemplary quinone for use in the device and methods of the invention is 1,8-dihydroxy-2,7-dicarboxymethyl-9,10-anthraquinone:

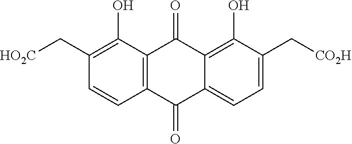 [SMILES: O=C(O)Cc1ccc2c(c1O)C(=O)c1c(ccc(CC(=O)O)c1O)C2=O]

(DCDHAQ) or a salt thereof.

Other organic species amenable to rebalancing according to methods of the invention include, but are not limited to, naphthoquinones (e.g., hydronaphthoquinones), reduced forms of phenazines (e.g., the reduced form of 7,8-dihydroxyphenazine-2-sulfonic acid), reduced monoquaternized or N,N′-diquaternized phenazines, reduced phenoxazines, reduced phenothiazine, or reduced forms of diquaternized bipyridines (e.g., alkyl viologen radical monocations).

Exemplary reduced phenazines, a N,N′-disubstituted phenazines, monoquaternized phenazines, or N,N′-diquaternized phenazines are, e.g., reduced forms (e.g., 5,10-dihydrophenazines) of formula (II):

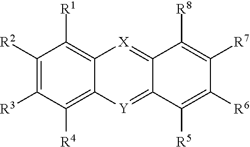

or a salt thereof,
where X and Y are both N, or where X is NR_{X} and Y is N, or where X is NR^{X} and Y is NR^{Y};
where R^{X} and R^{Y} are independently selected from H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; or a nitrogen protecting group;
where each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, or an ion thereof, where each Ra is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

In certain embodiments, each of R¹, R², R³, R⁴, R⁵, R⁶, R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R¹, R², R³, R⁴, R⁵, R⁶, R⁷, and R⁸ is independently selected from H, hydroxyl, optionally substituted C₁₋₄ alkyl, carboxyl, and SO₃H, such as each of R¹, R², R³, R⁴, R⁵, R⁶, R⁷ and R⁸ being independently selected from H, hydroxyl, optionally substituted C₁₋₄ alkyl (e.g., methyl), and oxo. In embodiments, at least one, e.g., at least two, of R¹, R², R³, R⁴, R⁵, R⁶, R⁷, and R⁸ is not H. In some embodiments, at least one of R₁-R₈ is a substituted alky or substituted alkoxy.

Exemplary phenazines include, e.g., 7,8-dihydroxyphenazine-2-sulfonic acid. Ions and reduced species thereof are also contemplated.

Exemplary reduced phenoxazines and phenothiazines are reduced forms of, e.g., formula (III):

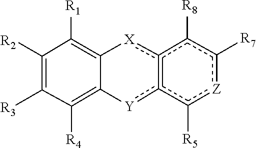

or a salt thereof,
where dashed bonds are single or double bonds; where X is N or NR^{X}, Y is O or S, and Z is CR⁶, C═O, C═S, C═NR^{Z}, or C═NH⁺R^{Z};
where R^{X} is selected from H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; or a nitrogen protecting group, where R^{Z} is selected from H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; or a nitrogen protecting group, where each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, or an ion thereof, where each Rₐ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

In certain embodiments, each of R¹, R², R³, R⁴, R⁵, R⁶, R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R¹, R², carboxyl, and SO₃H, such as each of R¹, R², R³, R⁴, R⁵, R⁶, R⁷ and R⁸ being independently selected from H, hydroxyl, optionally substituted C₁₋₄ alkyl (e.g., methyl), and oxo. In embodiments, at least one, e.g., at least two, of R¹, R², R³, R⁴, R⁵, R⁸, R⁷, and R⁸ is not H. In some embodiments, at least one of R¹-R⁸ is a substituted alky or substituted alkoxy.

Exemplary reduced diquaternized bipyridines are reduced forms (e.g., singly reduced radical monocations or doubly reduced 4,4′-bipyridinylidenes) of, e.g., formula (IV):

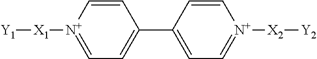

or a salt thereof,
where X₁ and X₂ are independently optionally substituted C₁₋₂₀ hydrocarbyl (e.g., C₁₋₁₀ alkylene) or heteroalkylene, and Y₁ and Y₂ are independently an optionally substituted water solubilizing group, e.g., a quaternary ammonium (e.g., trimethyl ammonium), ammonium, nitrogen-containing heterocyclyl, sulfonate, or sulfate. In certain embodiments, X₁ and X₂ are independently C₁₋₁₀ alkylene, e.g., C₃₋₆ alkylene. Exemplary groups for Y₁ and Y₂ are quaternary ammonium independently substituted with three C₁₋₆ hydrocarbyl groups, e.g., trimethyl ammonium. An exemplary diquaternized bipyridine is

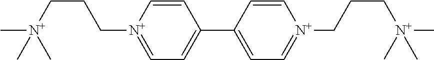

or a salt thereof.

In particular embodiments, the water-solubilizing group is charged at a pH between 6-8. Further embodiments of diquaternized bipyridines may have the above formula, except that the two pyridines are linked 2-2′ instead of 4-4′. Ions and reduced species thereof are also contemplated.

In some embodiments, the negolyte includes an organic species that is a naphthohydroquinone. The naphthohydroquinone may be a reduced for of a naphthoquinone, e.g., of formula (V):

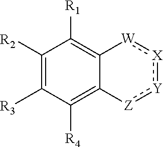

or a salt thereof,
wherein the dashed bonds are single or double bonds; where either W and X, Wand Z, or Z and Y are C═O, and where the two of W, X, Y, or Z that are not C═O are independently selected from C—R, where R is H; halo; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent R groups are joined to form an optionally substituted non-aromatic 3-6 membered ring, or an ion thereof, where each Rₐ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group; where each of R¹, R², R³, and R⁴ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, where each Rₐ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

In certain embodiments, each of R¹, R², R³, and R⁴ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R¹, R², R³, and R⁴ is independently selected from H, hydroxyl, optionally substituted C₁₋₄ alkyl, carboxyl, and SO₃H, such as each of R¹, R², R³, and R⁴ being independently selected from H, hydroxyl, optionally substituted C₁₋₄ alkyl (e.g., methyl), and oxo. In embodiments, at least one, e.g., at least two, of R¹, R², R³, and R⁴ is not H. In some embodiments, at least one of R¹-R⁴ is a substituted alkyl or substituted alkoxy. Ions and reduced species thereof are also contemplated.

Organic species, e.g., hydroquinones, may be present in a mixture. An organic species of the invention is a source of electrons during discharge and not merely a charge transfer agent. In embodiments, the organic species is water soluble. In some embodiments, the negolyte is a polymer, e.g., a polymer including a redox active species described herein, e.g., a polyquinone.

Organic species may be, e.g., those described in WO 2019/157437, WO 2018/032003, WO 2019/136374, WO2014/052682, and WO 2015/048550, which are hereby incorporated by reference.

In some embodiments, the negolyte includes an inorganic redox active species, e.g., vanadium (e.g., V₃₊/V₂₊) and a polysulfide (e.g., S₄²⁻/S₄⁴⁻).

The devices may also employ 2,2,6,6-tetramethylpiperidine N-oxyl (TEMPO) or a substituted version thereof (e.g., substituted like a heterocycle as described herein). Such species may be employed to capture CO₂ on the positive side of the device.

Examples of redox active species for the posolyte include bromine, chlorine, iodine, vanadium, chromium, cobalt, iron (e.g., ferricyanide/ferrocyanide or a ferrocene derivative, e.g., as described in WO 2018/032003), aluminum, e.g., aluminum (III) biscitrate monocatecholate, manganese, cobalt, nickel, copper, or lead, e.g., a manganese oxide, a cobalt oxide, or a lead oxide. A benzoquinone may also be used as the second redox active species. Other redox active species suitable for use in batteries of the invention are described in WO 2014/052682, WO 2015/048550, WO 2016/144909, and WO 2020/072406, the redox active species of which are incorporated by reference. The redox active species may be dissolved or suspended in solution (such as aqueous solution) or be in the solid state.

In some embodiments, the electrolytes are both aqueous, where the negolyte and posolyte, e.g., an anthraquinone and redox active species, are in aqueous solution or aqueous suspension. In addition, the electrolyte may include other solutes, e.g., acids (e.g., HCl) or bases (e.g., LiOH, NH₄OH, NaOH, or KOH) or alcohols (e.g., methyl, ethyl, or propyl) and other co-solvents to increase the solubility of a particular species, e.g., quinone/hydroquinone. Counter ions, such as cations, e.g., NH₄⁺, Li⁺, Na⁺, K⁺, or a mixture thereof, may also be present. In certain embodiments, the pH of one or both of the electrolytes may be >7, e.g., at least 8, 9, 10, 11, 12, 13, or 14, 8-14, 9-14, 10-14, 11-14, 12-14, 13-14, or about 14. In certain embodiments, the pH of one or both of the electrolytes may be <7, e.g., at less than 7, 6, 5, 4, 3, 2, or 1, e.g., 7-1, 7-5, 6-4, 5-2, 3-1, 2-1, or about 1. The pH may be less than 1. The pH may be a negative pH. The electrolyte may or may not be buffered to maintain a specified pH. The negolyte and posolyte will be present in amounts suitable to operate the device, e.g., battery or carbon capture device, for example, from 0.1-15 M, or from 0.1-10 M. In some embodiments, the solution is at least 10%, 20%, 30%, 40%, 50%, 60%, 70%, or 80% water, by mass. Negolytes, e.g., organic species, e.g., quinones, hydroquinones, salts, and/or ions thereof, or inorganic species, e.g., polysulfides, may be present in a mixture.

The concentration of the organic species and redox active species may be any suitable amount. Ranges include, for example, from 0.1 M to liquid species, e.g., 0.1-15 M. In addition to water, solutions or suspensions may include alcohols (e.g., methyl, ethyl, or propyl) and other co-solvents to increase the solubility of a particular species. In some embodiments, the solution or suspension is at least 10%, 20%, 30%, 40%, 50%, 60%, 70%, or 80% water, by mass. Alcohol or other co-solvents may be present in an amount required to result in a particular concentration of species. The pH of the aqueous solution or suspension may also be adjusted by addition of acid or base, e.g., to aid in solubilizing a species.

Electrodes are disposed to provide an electrical pulse to the posolyte and negolyte. The voltage requirements for the electrical pulse may depend upon the electrochemical properties of the posolyte and negolyte. In certain embodiments the electrodes are disposed to provide the electrical pulse at a potential sufficient to reduce the redox active species in the posolyte and oxidize a component of the negolyte (e.g., an oxidation reaction product of the first redox active species with molecular oxygen, e.g., H₂O or OH⁻) to a gaseous oxidation product (e.g., molecular oxygen or water), e.g., at a potential that is more negative than the discharge cycle voltage of the electrochemical system, e.g., about 50-100 mV, 100-300 mV, 200-600 mV, 100-700 mV, 500-1000 mV, 400-800 mV, 300-900 mV, 1000-1500 mV, 800-1200 mV, 400-1400 mV, or 1200-1500 mV, e.g., about 50 mV, 100 mV, 200 mV, 300 mV, 400 mV, 500 mV, 600 mV, 700 mV, 800 mV, 900 mV, 1000 mV, 1100 mV, 1200 mV, 1300 mV, 1400 mV, or 1500 mV, e.g., at least 100 mV, 200 mV, 300 mV, 400 mV, 500 mV, 600 mV, 700 mV, 800 mV, 900 mV, 1000 mV, 1100 mV, 1200 mV, 1300 mV, 1400 mV, or 1500 mV more negative than the reduction potential of a redox active species in the posolyte.

The barrier allows the passage of ions, such as sodium or potassium, but not a significant amount of the negolyte or other redox active species. Examples of ion conducting barriers are NAFION®, i.e., sulfonated tetrafluoroethylene based fluoropolymer-copolymer, FUMASEP®, i.e., non-fluorinated, sulfonated polyaryletherketone-copolymer, e.g., FUMASEP® E-620(K), hydrocarbons, e.g., polyethylene, and size exclusion barriers, e.g., ultrafiltration or dialysis membranes with a molecular weight cut off of 100, 250, 500, or 1,000 Da. For size exclusion membranes, the required molecular weight cut off is determined based on the molecular weight of the negolytes and posolytes employed. Porous physical barriers may also be included, e.g., when the passage of redox active species is tolerable. A redox cell may have two barriers and a central compartment disposed therebetween.

A device, e.g., battery or carbon capture device, amenable to rebalancing according to methods of the invention may include additional components as is known in the art. Negolytes and posolytes may be housed in a suitable reservoir. A device, e.g., battery or carbon capture device, may include one or more flow cells and further include one or more pumps to pump the posolyte and/or negolyte past one or both electrodes. Alternatively, the electrodes may be placed in a reservoir that is stirred or in which the solution or suspension is recirculated by any other method, e.g., convection, sonication, etc. A device, e.g., battery or carbon capture device, may also include graphite flow plates and corrosion-resistant metal current collectors.

The device may further include fluid handling and storage elements, and voltage and round-trip energy efficiency measurements can be made. Systems configured for measurement of negolyte and posolyte flows and pH, pressure, temperature, current density and cell voltage may be included and used to evaluate cells, e.g., to determine when to apply the electrical pulse. Fluid sample ports can be provided to permit sampling of both electrolytes, which will allow for the evaluation of parasitic losses due to reactant crossover or side reactions. Electrolytes can be sampled and analyzed with standard techniques.

Suitable cells, electrodes, membranes, and pumps for redox flow batteries are known in the art, e.g., WO 2014/052682, WO 2015/048550, WO 2016/144909, and WO 2020/072406, the battery components of which are hereby incorporated by reference.

Carbon Capture with Proton-Coupled Redox Active Species

The invention can be used for an electrochemical CO₂ capture system, e.g., employing proton-coupled redox active species whose protonation and deprotonation can be controlled electrochemically to modify the pH of an aqueous solution or aqueous suspension. This change in pH can be used to sequester and release CO₂. The CO₂ capture device can be used to sequester gaseous CO₂ from a point source, such as flue gas, or from ambient air. The total possible amount of sequestered carbon, the Dissolved Inorganic Carbon (DIC), depends on the partial pressure of CO₂ above the aqueous solution or aqueous suspension, and the pH determines the form of the carbon, e.g., dissolved CO₂, HCO₃⁻; or CO₃²⁻. CO₂ can be captured from a gaseous source, e.g., point sources or ambient air, by dissolving into an aqueous solution. More CO₂ can be dissolved as the pH of the aqueous solution or aqueous suspension increases, resulting in the conversion of CO₂ into HCO₃⁻ or CO₃²⁻ ions. More CO₂ can be dissolved in an aqueous solution or aqueous suspension as HCO₃⁻ or CO₃²⁻ than CO₂, resulting in supersaturation of CO₂ in the aqueous solution or aqueous suspension. Once captured, the CO₂ can be released by acidifying the aqueous solution or aqueous suspension. In principle, the pure CO₂ obtained after separation can be converted back into useful chemical fuels and feedstocks with carbon-free energy, thus providing fuels and feedstocks without added CO₂ emissions.

The use of redox-active species and cell architectures that impose minimal kinetic losses while preserving the pH gradient would be advantageous to realizing electrochemical CCS at low energetic cost. In some embodiments, the electrochemical carbon capture cycle described herein may operate with an ion-selective membrane and be able to make use of any redox-active species within a wide array of reactants capable of PCET. In the AORFB literature, several organic molecules have been shown to have kinetic rate constants on the order of 10⁻³ cm/s or above on inexpensive carbon electrodes, demonstrating the wide availability of reactants for CO₂ separation that will impose minimal energetic losses in an electrochemical cell.

In addition to minimal energetic losses, another important criterion for wide scale adoption of CO₂ separation technology is the use of low-cost cell components and working fluids. The process described here can, in principle, use water-soluble molecules and aqueous electrolytes. This is in contrast to most of the electrochemical CO₂ separation methods that do not feature the use of a pH swing which have been described in the literature, involving direct binding of CO₂ to reduced quinones and oxygen-assisted conversion of CO₂ to oxalate species-all of which require more expensive organic solvents to operate.

Electrochemically mediated amine regeneration (EMAR) has been experimentally demonstrated to require an exceptionally low electrical energy input of 100 KJ/mol_{CO2}, which is comparable to what may be expected of our process assuming similar second-law efficiencies.

When a voltage is applied to an aqueous solution or aqueous suspension containing a proton-coupled redox active species, e.g., a hydroquinone, a hydrophenazine, or others, the proton-coupled redox active species is reversibly oxidized, releasing one or more protons or electrons. The protons released reduce the pH of the aqueous solution or aqueous suspension, resulting in the release of CO₂ from the aqueous solution. Reducing the proton-coupled redox active species after releasing CO₂ then increases the pH of the aqueous solution or aqueous suspension by removing protons, thereby allowing absorption of more CO₂ at higher pH.

An advantage of this invention is the reduced energy input required to capture CO₂. In general, all methods of capturing CO₂ require some level of energy input, e.g., thermal, electrical, or both. Most currently available methods require anywhere from ˜100 to 600 KJ/mol_{CO2} to capture CO₂ because of losses from metal catalyst interactions (e.g., binding), water splitting reactions, and/or other endothermic processes, such as material regeneration. In contrast, CO₂ capture devices used with the present invention eliminate the need for thermal energy input and reduce the electrical energy input required to potentially between 15-70 KJ/mol_{CO2} (e.g., 30-70 KJ/mol_{CO2}), about 30% less energy intensive than competing technologies. The present invention also does not require water splitting or metal catalysts for operation.

### CO₂ Capture Devices

CO₂ capture devices to which methods of the invention may be applied can be based on the use of a proton-coupled redox active species, e.g., those disclosed herein, e.g., a hydrophenazine/phenazine couple, hydroquinone/quinone couple, or other redox-active couple. FIG. 1 provides a device configured to capture and then release CO₂, e.g., from either flue gas or air. Gas containing CO₂ contacts the negolyte containing a proton-coupled redox active species at a high pH. This region also includes a gas outlet to allow the carrier source gas, e.g., flue gas or air, to exit the device after being depleted of CO₂.

Nitrogen or other inert gas may be used to purge the negolyte of dissolved gases, e.g., oxygen or CO₂. The outlet may be connected to a storage container for CO₂.

In some cases, the CO₂ capture device includes two or more electrochemical cells, with each cell having its electrodes separated by both a cation-exchange membrane (CEM) and an anion exchange membrane (AEM). In this configuration, the use of both a CEM and an AEM in each electrochemical cell blocks the crossover of anionic proton acceptors and H⁺, respectively. This device configuration allows the electrochemical cell to be integrated within an aqueous flow battery architecture for simultaneous CCS and energy storage/conversion. Each electrochemical cell is configured to include additional redox processes occurring counter to the redox processes of the redox-active couple that drives the capture and release of CO₂ in the device. The counter redox processes may be symmetric with respect to the redox-active couple that drives the capture and release of CO₂ in the device, e.g., if the redox process driving CO₂ capture and release is Q/QH₂, then the counter process is QH₂/Q. Alternatively, the counter redox processes may be asymmetric with respect to the redox-active couple that drives the capture and release of CO₂ in the device. The counter redox active species may be any suitable species, such as bromine, chlorine, iodine, oxygen, vanadium, chromium, cobalt, iron, e.g., ferricyanide/ferrocyanide, aluminum, e.g., aluminum (III) biscitrate monocatecholate, manganese, cobalt, nickel, copper, or lead, e.g., a manganese oxide, a cobalt oxide, or a lead oxide.

During invasion, the high-pH liquid may be sprayed down through a solid lattice, providing a liquid/gas interface for CO₂ in the gas to enter the liquid. A similar lattice may be employed when CO₂ gas is released from the liquid.

### Ion Conducting Barriers for CO₂ Capture

The ion conducting barrier allows the passage of ions from an aqueous solution, but preferably not a significant amount of the proton-coupled redox active species. In particular, an anionic exchange membrane can be used, e.g., to allow chloride ions to pass. Anion specific conducting barriers are typically ionomers, e.g., ion-conducting polymers, including, but not limited to aromatics, e.g., xylylenes, polysulfones, e.g., polyethersulfone, and amine functionalized fluoropolymers, e.g., FUMASEP®. Examples of membranes include Selemion DSV and Selemion AMV. Other anion-specific ion conducting barriers are known in the art.

### Proton-Coupled Redox Active Species for CO₂ Capture

Exemplary proton-coupled redox active species for use in carbon capture redox flow cells include organic species such as described herein, e.g., quinones, phenazines (e.g., phenazine dihydroxysulfonic acid), alloxazines, isoalloxazines, polyoxometalates (e.g., tungsten-based polyoxoanion), and their reduced counterparts. The ability of phenazines and quinones to both accept and release a proton at modest electrical potentials makes them ideal candidates for creating pH “swings” in an aqueous solution.

### Electrode Materials

Electrodes for use with batteries and CO₂ capture devices may include any carbon electrode, e.g., glassy carbon electrodes, carbon paper electrodes, carbon felt electrodes, or carbon nanotube electrodes. Titanium electrodes may also be employed. Electrodes can also be made of a high specific surface area conducting material, such as a nanoporous metal sponge (T. Wada, A. D. Setyawan, K. Yubuta, and H. Kato, Scripta Materialia 65, 532 (2011)), which has been synthesized previously by electrochemical dealloying (J. D. Erlebacher, M. J. Aziz, A. Karma, N. Dmitrov, and K. Sieradzki, Nature 410, 450 (2001)), or a conducting metal oxide, which has been synthesized by wet chemical methods (B. T. Huskinson, J. S. Rugolo, S. K. Mondal, and M. J. Aziz, arXiv: 1206.2883 [cond-mat.mtrl-sci]; Energy & Environmental Science 5, 8690 (2012); S. K. Mondal, J. S. Rugolo, and M. J. Aziz, Mater. Res. Soc. Symp. Proc. 1311, GG10.9 (2010)). Chemical vapor deposition can be used for conformal coatings of complex 3D electrode geometries by ultra-thin electrocatalyst or protective films. Other electrodes are known in the art.

### Methods

As described, the invention provides methods for reducing the loss of capacity due to reactions with molecular oxygen in electrochemical systems, e.g., AORFB or PCET carbon capture systems. In the methods, an electrical pulse sufficient to generate a gaseous oxidation product (e.g., molecular oxygen) on the negolyte side rebalances the electrochemical system unbalanced by reaction of the negolyte with molecular oxygen (e.g., to produce oxidized redox active species and OH⁻). The electrical pulse may also reduce the redox active species in the posolyte.

In addition to carbon capture cells (e.g., flow cells), which employ organic PCET systems that have pH swing ranging from neutral to basic, the electrochemical rebalancing method can be applied to other aqueous based electrochemical systems, including organic and inorganic, PCET or non-PCET, acidic or basic, dissolved or solid redox active materials. The following are examples of electrochemical systems to which the methods of the invention may be applied.

Organic Non-PCET System in Neutral Aqueous Solution: Fe(CN)₆ (posolyte)|Viologen (negolyte) Flow Battery

When the viologen-based redox flow battery is charged: oxygen can chemically oxidize the reduced viologen to the oxidized state, accumulating hydroxide in the negolyte, leading to the negolyte to discharged state and the posolyte active species maintaining the oxidized state. Since the redox active core of viologens have two positive charges, their oxidized is Vi²⁺ and the single-electron reduced form is Vi⁺. The battery gets “self-discharged.”

½O₂+2Vi⁺+H₂O→Vi²⁺+2OH⁻

The electrochemical rebalancing method can remove the accumulated hydroxide, repelling O₂:

2OH⁻→1OH₂+H₂O+2e⁻

During the electrochemical rebalancing process, the electrons are transferred to the posolyte side, which has accumulated Fe(CN)₆³⁻, and eventually both negolyte and posolyte sides are recover the their initial composition, i.e., Fe(CN)₆⁴⁻ in posolyte and Vi²⁺ in negolyte, rebalancing the system.

Inorganic Non-PCET system in strongly acidic aqueous solution: VO²⁺/VO⁺ (posolyte)|V³⁺/V²⁺ (negolyte) Flow Battery

When a vanadium redox flow battery negolyte contains the charged form, i.e., V²⁺: if oxygen diffuses into the negolyte, it can chemically oxidize V²⁺ to V³⁺, and hydroxide is accumulated in the negolyte,

½O₂+2V²⁺+H₂O→V³⁺+2OH⁻

The electrochemical rebalancing method can remove the accumulated hydroxide, repelling O₂:

2OH⁻→½O₂+H₂O+2e⁻

Since the electrolyte of a vanadium redox flow battery is strongly acidic, the hydroxide is readily neutralized to water. Hence the oxidation reaction is:

½O₂+2V²⁺+2H⁺→V³⁺+H₂O

Thus, instead of generating two hydroxides in the negolyte, the oxidation by oxygen reaction causes the loss of two protons. And the electrochemical rebalancing method in such scenario is as follows:

H₂O→½O₂+2H⁺+2e⁻

During the electrochemical rebalancing process, the electrons are transferred to the posolyte side, which has accumulated the oxidized form VO²⁺, through

(2VO²⁺+2e⁻→2VO₂⁺)

and eventually both negolyte and posolyte sides are restored to the initial state (VO²⁺ for posolyte and V³⁺ for negolyte), thus rebalancing the system.
Inorganic Non-PCET System in Basic Aqueous Solution: Air (Posolyte)|S₄²⁻/S₄⁴⁻ (Negolyte) Battery

When a sulfur-air flow battery is charged: if oxygen diffuses into the polysulfide negolyte, oxygen can chemically oxidize polysulfide, and hydroxide is accumulated in the negolyte:

½O₂+2S₄⁴⁻+H₂O→2S₄²⁻+2OH⁻

The electrochemical rebalancing method can remove the accumulated hydroxide, repelling O₂:

2OH⁻→½O₂+H₂O+2e⁻

During the electrochemical rebalancing process, the electrons are transferred to the posolyte side externally, eventually both negolyte and posolyte sides are discharged, thus rebalancing the system.

### Solid Polyquinone Non-PCET System for Carbon Capture: LiFePO₄ (Cathode)|Polyquinone (Anode)

Liu et al. (Nature Communications 2020, 11, 2278) demonstrated a solid quinone aqueous carbon capture system, where the cathode is LiFePO₄ and the anode is a polyquinone (PAQ) tethered to a carbon electrode. The authors utilized a 20 molal LiTFSI aqueous solution to ensure that the reduced PAQ are deprotonated, i.e., PAQ²⁻, which then binds with CO₂ to form PAQ-CO₂ adduct. Oxygen in this system can cause long term imbalance (accumulation of oxidized cathode material and accumulated LiOH in the anode side).

When the anode is charged: oxygen can chemically oxidize the air-sensitive anode, and hydroxide is accumulated in the negolyte:

½O₂+H₂O+PAQ²⁻→PAQ+2OH⁻

The electrochemical rebalancing method can remove the accumulated hydroxide, repelling O₂:

2OH⁻→½O₂+H₂O+2e⁻

During the electrochemical rebalancing process, the electrons are transferred to the cathode side externally, eventually both anode and cathode are discharged, rebalancing the system.

Methods of the invention include rebalancing the electrochemical device by, e.g., application of an electrical pulse. For example, providing an electrical pulse of appropriate potential to the negolyte and posolyte for a time sufficient to revert at least half of the redox active species in the posolyte to its reduced form and produce an amount of gaseous oxidation product equimolar to at least half the amount of negolyte redox active species to have been oxidized by molecular oxygen. The electrical pulse may be sufficient to revert, for example, at least 1% of the redox active species in the posolyte to its reduced form, e.g., from about 1% to 100% (e.g., about 1-10%, about 10-20%, about 20-30%, about 30-40%, about 40-50%, about 50-60%, about 60-70%, about 70-80%, about 80-90%, or about 90-100% or at least about 10%, at least about 25%, at least about 50%, at least about 75%, or at least about 95%).

The duration of the electrical pulse may depend on, e.g., the volume of negolyte. The electrical pulse may be applied for at least 1 min (e.g., about 1 to 2 min, 2 to 3 min, 3 to 4 min, 4 to 5 min, 5 min to 6 min, 6 min to 7 min, 7 min to 8 min, 8 min to 9 min, or 9 min to 10 min), or, e.g., at least 10 min (e.g., about 10 to 20 min, 20 to 30 min, 30 to 40 min, 40 to 50 min, or 50 min to 60 min, or longer). The electrical pulse may be applied for between about 0.1 to about 48 hours (e.g., about 0.1 to 1 hours, 1 to 2 hours, 2 to 3 hours, 3 to 5 hours, 5 to 10 hours, 10 to 20 hours, 20 to 30 hours, 30 to 40 hours, or about 40 to 50 hours). The duration of the electrical pulse may be several days, e.g., between about 1 to 14 days (e.g., about 1 to 2 days, 2 to 5 days, 5 to 10 days, or 10 to 14 days.

The pulse can either be ‘potentiostatic’ (e.g., at constant potential), or ‘galvanostatic’ (e.g., at constant current), or mixture of both. The potential during the pulse may be variable. Where the potential during the pulse is variable, it may range between 50 mV to 1500 mV, e.g., about 50-100 mV, 100-300 mV, 200-600 mV, 100-700 mV, 500-1000 mV, 400-800 mV, 300-900 mV, 1000-1500 mV, 800-1200 mV, 400-1400 mV, or 1200-1500 mV, e.g., about 50 mV, 100 mV, 200 mV, 300 mV, 400 mV, 500 mV, 600 mV, 700 mV, 800 mV, 900 mV, 1000 mV, 1100 mV, 1200 mV, 1300 mV, 1400 mV, or 1500 mV, e.g., at least 100 mV, 200 mV, 300 mV, 400 mV, 500 mV, 600 mV, 700 mV, 800 mV, 900 mV, 1000 mV, 1100 mV, 1200 mV, 1300 mV, 1400 mV, or 1500 mV more negative than the open circuit voltage in fully discharged state, e.g., for at least about 1% of the pulse time, e.g., about 1% to 99% of the pulse time, (e.g., about 1-10%, 10-20%, 20-30%, 30-40%, 40-50%, 50-60%, 60-70%, 70-80%, 80-90%, or 10-100% of the pulse time).

In embodiments of the methods described herein, the device is cycled for a given number of cycles, e.g., 100 times, 1000 time, 10,000 times, etc., before the pulse is applied. In some embodiments, the pulse is applied once the device is measured to have a certain condition, e.g., having the capacity fully or partially (e.g., 1-10% 100-20%, 20-30%, 30-40%, 40-50%, 50-60%, 60-70%, 70-80%, 80-90%, or 90-99%) depleted, or, e.g., having a certain pH (e.g., between 9 and 14, or about 14, or greater than 14). The method may be automated. A neutral carrier gas may be used to purge the gaseous oxidation product generated by the electrical pulse. Alternatively, a negative pressure may be applied to remove the gaseous oxidation product. In a carbon capture system, components for collecting captured carbon may be applied to remove CO₂ produced (see Table 1) by the electrical pulse.

The methods of the invention may be employed to reduce loss of capacity as a function of time (independent of the number of cycles). In embodiments, the methods reduce the loss of capacity to a rate of less than 5% per day, e.g., less than 4, 3, 2, 1, 0.5, 0.1, 0.05, or 0.001. For example, the loss of capacity may be between 0.0001-5% per day, e.g., 0.0001-1%, 0.0001-0.1%, 0.0001-0.05%, 0.001-1%, 0.001-0.1%, 0.001-0.05%, 0.01-1%, 0.01-0.5%, or 0.01-0.1%. The methods may be practiced for a period of at least one week, one month, six months, or one year. The method may be applied to any organic or organometallic redox active species, such as an anthraquinone as described herein.

### EXAMPLES

The invention will be further described by the following non-limiting examples.

### Example 1—Experimental Demonstration of the Electrochemical Rebalancing Method for AORFB

Electrochemical rebalancing according to methods of the invention was demonstrated with a flow battery composed of 35 mL 0.1 M Fe(CN)₆⁴⁻ plus 0.04 M Fe(CN)₆³⁻ in 1 M KCl solution as posolyte and 11 mL 0.1 M sodium 3,3′-(phenazine-2,3-diyl)bis(propane-1-sulfonate) (DSPZ) in 1 M KCl as negolyte. Note that the theoretical capacity of the posolyte side and negolyte side is 472 Coulombs and 212 (capacity-limiting) Coulombs, respectively and both sides have an initial pH of ˜9. The membrane used is Fumasep E-620 (K) cation exchange membrane, and the electrodes are 4 pieces Sigracet SGL39AA.

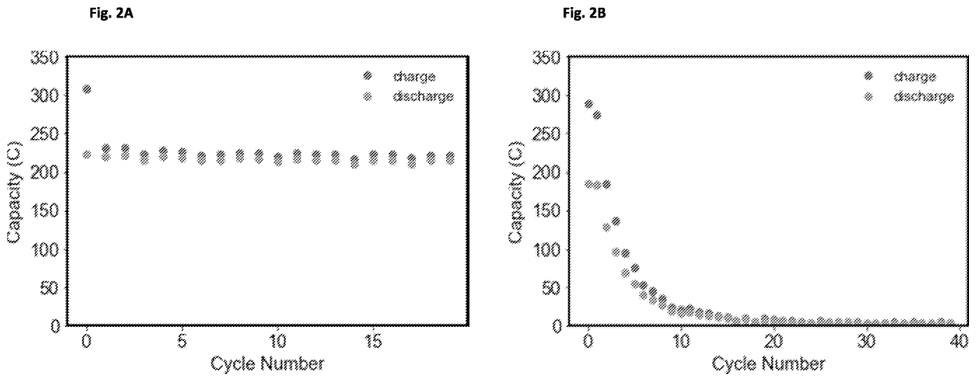

The battery was first cycled (repeatedly going through processes #1 and #6) under inert (N₂) atmosphere. The cycling protocol was at a constant current of ±40 mA/cm² with potential cutoffs of 1.65 V for charging and 0.2 V for discharging. When the potential cutoff is reached, the cell keeps going through potentiostatic cycling until the current reaches ±10 mA/cm² cutoff. As shown in FIG. 2A, the charge and discharge capacity are slightly above the theoretical capacity (this is normal due to measurement error during solution preparation) of the capacity-limiting negolyte side, and quite stable across a total of 20 cycles. The inert gas protection was then removed, and the battery was cycled under air. Thus, in addition to processes #1 and #6, process #3 takes place whenever reduced DSPZH₂ (i.e., QH₂) is present and causes the imbalance. FIG. 2B shows the result for 40 such cycles. It is evident that the cell becomes out of balance (the posolyte becomes capacity-limiting) immediately after two cycles and the capacity fades because of insufficient Fe(CN)₆⁴⁻ in the posolyte side to supply process #1. The pH of the negolyte also shifts to ˜14 in the end of the 40 cycles due to the accumulation of hydroxide, as explained above.

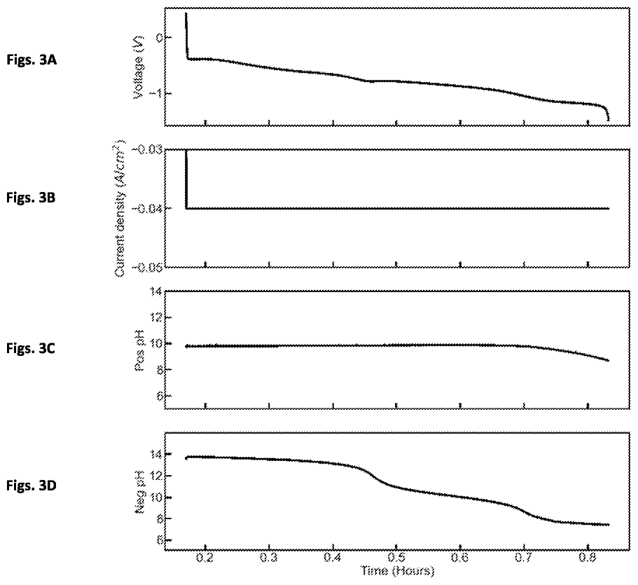

As shown in FIG. 3, the electrochemical rebalancing (process #4) was performed by a −40 mA/cm² (or 200 mA since the electrode geometric area is 5 mA/cm²) current was applied to the completely out-of-balance cell. The voltage immediately dropped from 0.2 V to negative values because the both the cathodic and anodic half reactions were ˜0.4 V vs. SHE at pH 14 and there was high overpotential for the oxygen evolution reaction. As the rebalancing process progressed, the pH of the negolyte side decreased (FIG. 3D), causing the anodic half reaction to shift to higher potential, thus further decreasing the cell potential (FIG. 3A). The sharp drop in voltage at 0.83 hour indicated the completion of the electrochemical rebalancing process. The capacity accounting for all the electrons passed in this process was 476.8 Coulombs, obtained from integrating the current value in part FIG. 3B. This capacity was only slightly above the theoretical capacity of the posolyte side, suggesting a complete recovery of the initial posolyte. The neutral pH of the negolyte in the end of the process indicated the accumulated hydroxide had been removed. The overall energy cost was 378 J, which is a negligible amount if this method is applied once every hundred cycles to mitigate slow oxygen permeation or occasional oxygen leakage due to failure of cell parts.

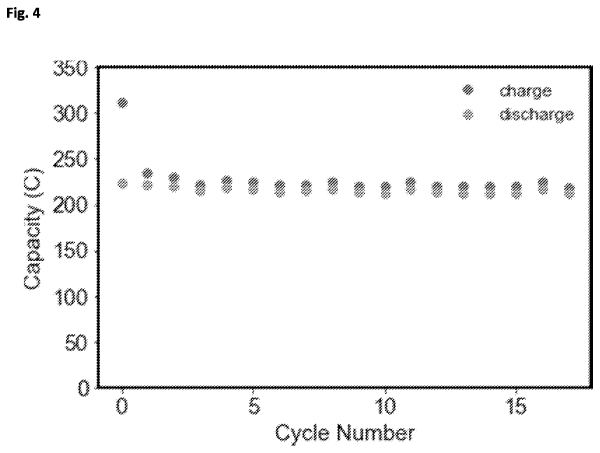

After the electrochemical rebalancing step, the electrolytes were once again purged continuously with nitrogen. FIG. 4 shows the post-rebalancing cell cycling data, which were almost identical to the pre-air-exposure cycling. This clearly indicated that all the lost capacity due to imbalance had been restored. The fact that the capacity does not decrease also shows that this method is not detrimental to the redox active molecules. Hence, the electrochemical rebalancing method is a very effective way to remove the adverse effect of oxygen in AORFB.

### Example 2—Applying the Electrochemical Rebalancing Method in Carbon Capture

The electrochemical reactions that take place in an electrochemical carbon capture flow cell are essentially the same as in a flow battery. The additional reactions, however, are the chemical reactions between hydroxide and CO₂. Process #2 and #4 in Table 1 denote the CO₂ capture and evolution steps, respectively. Note that only the bicarbonate reaction is included here for convenience. When it comes to the adverse effect of oxygen, process #3 once again shifts the balance of the posolyte side toward complete Fe(CN)₆³⁻, but now HCO₃⁻, instead of OH⁻, accumulates in the negolyte side. Again, without rebalancing, the cell is not capable of performing further carbon capture duties. As the electrochemical rebalancing process proceeds, there will be simultaneous decomposition of HCO₃⁻ and evolution of CO₂, i.e., process #5, the cell balance will be restored eventually.

Other embodiments are in the claims.

What is claimed is:

1. A method of rebalancing an electrochemical device comprising the steps of:
a) providing an electrochemical device comprising a negolyte comprising a first redox active species having a reduced form and an oxidized form in contact with a first electrode, a posolyte comprising a second redox active species having a reduced form and an oxidized form in contact with a second electrode, and a barrier separating the negolyte and posolyte, wherein when the electrochemical device is charged, the reduced form of the first redox active species reacts with molecular oxygen to form the oxidized form of the first redox active species while the second redox active species remains in the oxidized form, thereby electrochemically unbalancing the electrochemical device; and wherein a discharge reaction or reaction with molecular oxygen produces an OH⁻ ion; and
b) applying an electrical pulse across the electrochemical device sufficient to produce a gaseous oxidation product in the negolyte.

2. The method of claim 1, wherein the electrical pulse reverts the oxidized form of the second redox active species to the reduced form of the second redox active species.

3. The method of claim 1, further comprising (c) removing the gaseous oxidation product.

4. The method of claim 1, wherein the electrical pulse is applied every 100 cycles.

5. The method of claim 3, wherein the gaseous oxidation product is removed by flowing a carrier gas through the electrochemical device or by applying negative pressure.

6. The method of claim 1, wherein the electrical pulse lowers the pH of the negolyte.

7. The method of claim 1, wherein step (a) further comprises monitoring a capacity of the electrochemical device or a pH of the negolyte to determine when to apply the pulse of step (b).

8. The method of claim 7, wherein step the pulse of step (b) is applied when the pH is greater than 9.

9. The method of claim 7, wherein the pulse of step (b) is applied when the pH is about 14.

10. The method of claim 7, wherein the pulse of step (b) is applied when the capacity is below 90% of an initial capacity.

11. The method of claim 1, wherein the electrochemical device provided is a battery and step (a) further comprises:
i) charging the battery, and
ii) connecting a load to the first and second electrodes and allowing the battery to discharge.

12. The method of claim 11, wherein step (b) comprises biasing the battery at a voltage more negative than a discharging voltage of the battery.

13. The method of claim 11, wherein the gaseous oxidation product is molecular oxygen and step (b) comprises oxidizing OH⁻ or H₂O in the negolyte to molecular oxygen.

14. The method of claim 1, wherein the electrochemical device is a carbon capture cell and step (a) further comprises:
i) applying a voltage across the first and second electrodes to charge the electrochemical device and produce OH⁻ ions;
ii) providing a source of CO₂ to the negolyte to dissolve CO₂ and react it with the OH⁻ ions; and
iii) connecting a load to the first and second electrodes and allowing the electrochemical device to discharge and release CO₂.

15. The method of claim 1, wherein the first and second redox active species have the same reduced and oxidized forms.

16. The method of claim 1, wherein the first and second redox active species have different reduced and oxidized forms.
